(19) United States
(12) Patent Application Publication
(10) Pub. No.: US 2007/0015508 A1
(43) Pub. Date: Jan. 18, 2007

(54) Method of adaptive power control

(76) Inventors: Jonathan H. Gross, Gilbert, AZ (US); Shawn W. Hogberg, Chandler, AZ (US); Daniel R. Tayloe, Phoenix, AZ (US)

Correspondence Address: MOTOROLA, INC., LAW DEPARTMENT, 1303 E. ALGONQUIN ROAD, SCHAUMBURG, IL, 60196, US

(21) Appl. No.: 11/180,365

(22) Filed: Jul. 13, 2005

(51) Int. Cl. H04Q 7/20

(52) U.S. Cl. 455/436; 455/522

(57) ABSTRACT

In a mobile communication system, an adaptive power control method may include determining by a network unit (209) of the mobile communication system a message type (252) of a control message (250) transmitted to a mobile unit (202), determining message content (254) of the control message, determining whether the control message is being retransmitted (256) and selectively increasing power gain for the control message based on at least one of the message type, the message content and whether the control message is being retransmitted.

### BACKGROUND OF INVENTION

In a CDMA system, there is a strong relationship between system capacity, RF power, interference, and call quality. As call quality is increased, the power consumed by the system tends to increase. This situation consumes limited available cell power and increases system interference, which in turn reduces system capacity from an RF perspective. This is a particularly important aspect of efficient CDMA systems.

Call quality in this context includes voice quality which can be measured by frame erasure rate; mean-opinion score (MOS score) which is a measure of voice quality; data throughput for data services; and call reliability which includes call setup success rate and the dropped call rate. This relationship is well known to those skilled in the art. Therefore, there is a fundamental tradeoff between call performance (FER/quality, call reliability, and messaging reliability) and system capacity. As the link performance is increased FER is typically lowered, additional power is consumed, interference is generated, and capacity is reduced.

For establishing and maintaining voice communication between cellular users, control or signaling messaging is required. A traffic channel carries, among other things, voice samples of each person speaking as well as signaling and control messaging such as handoff related messaging for a cellular subscriber moving from one cell to another.

Currently, mobile communication systems may boost the power gain for data bits of all signaling messages in order to achieve a lower target FER and higher probability of delivery. However, providing this additional signaling boost degrades system RF capacity. The current method of boosting power gain for all signaling messages is inefficient as not all signaling messages are of equal importance.

Accordingly, it would be desirable to have an adaptive method that discriminates among signaling messages, boosting only those signaling messages that are critical to call performance.

### BRIEF DESCRIPTION OF THE DRAWINGS

Representative elements, operational features, applications and/or advantages of the present invention reside inter alia in the details of construction and operation as more fully hereafter depicted, described and claimed—reference being made to the accompanying drawings forming a part hereof, wherein like numerals refer to like parts throughout. Other elements, operational features, applications and/or advantages will become apparent in light of certain exemplary embodiments recited in the Detailed Description, wherein:

FIG. 1 representatively illustrates a block diagram of a cellular communication system in accordance with an exemplary embodiment of the present invention;

FIG. 2 representatively illustrates a block diagram of a method of sorting control messages in accordance with an exemplary embodiment of the present invention; and

FIG. 3 representatively illustrates a flow diagram of a method of the invention in accordance with an exemplary embodiment of the present invention.

Elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms “first”, “second”, and the like herein, if any, are used inter alia for distinguishing between similar elements and not necessarily for describing a sequential or chronological order. Moreover, the terms “front”, “back”, “top”, “bottom”, “over”, “under”, and the like in the Description and/or in the Claims, if any, are generally employed for descriptive purposes and not necessarily for comprehensively describing exclusive relative position. Any of the preceding terms so used may be interchanged under appropriate circumstances such that various embodiments of the invention described herein may be capable of operation in other configurations and/or orientations than those explicitly illustrated or otherwise described.

### DETAILED DESCRIPTION OF EXEMPLARY EMBODIMENTS

The following representative descriptions of the present invention generally relate to exemplary embodiments and the inventor's conception of the best mode, and are not intended to limit the applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

For clarity of explanation, the embodiments of the present invention are presented, in part, as comprising individual functional blocks. The functions represented by these blocks may be provided through the use of either shared or dedicated hardware, including, but not limited to, hardware capable of executing software. The present invention is not limited to implementation by any particular set of elements, and the description herein is merely representational of one embodiment.

Software blocks that perform embodiments of the present invention can be part of computer program modules comprising computer instructions, such control algorithms, which are stored in a computer-readable medium such as memory. Computer instructions can instruct processors to perform any methods described below. In other embodiments, additional modules could be provided as needed.

A detailed description of an exemplary application is provided as a specific enabling disclosure that may be generalized to any application of the disclosed system, device and method for adaptive power control in accordance with various embodiments of the present invention.

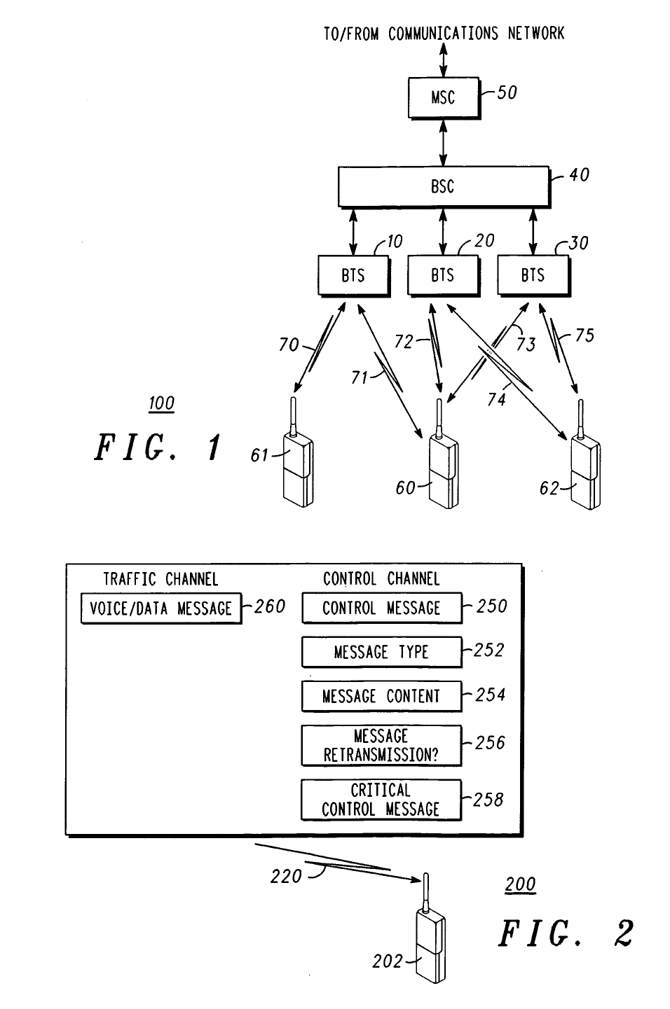

FIG. 1 is a block diagram depicting a cellular communication system 100. The cellular communication system 100 which embodies the present invention may include a CDMA (Code Division Multiple Access), TDMA (Time Division Multiple Access), GSM (General System Mobile), UMTS (Universal Mobile Telecommunication System) or other such cellular based communication systems. Cellular communication system 100 includes mobile switching center (MSC) 50 coupled to base station controller (BSC) 40. Base station controller 40 is coupled to base stations (BTS) 10, 20 and 30. Base stations 10-30 may be coupled to mobile units 60, 61, and 62.

Each mobile unit 60-62 is coupled to at least one of the base stations 10-30. Mobile unit 60 is coupled to each base station 10-30 via mobile links 71, 72 and 73 respectively. Each of these mobile links may also be referred to as “call legs” or “soft handoff legs”. Mobile unit 60 is coupled to each of the base stations 10-30 since it is in “soft-handoff” (SHO) with these base stations (and thus has multiple soft-handoff legs). The base stations are constantly transmitting the same data for diversity benefits. Within a call, base stations or soft-handoff legs may be dropped and others may be added.

Mobile unit 61 is coupled via mobile link 70 only to base station 10, since no soft-handoff is involved. Mobile unit 62 is also in soft-handoff since it is coupled to base stations 20 and 30 via mobile links 74 and 75 respectively.

The base stations 10-30 control the power with which the mobile units 60-62 send data on the reverse link. Similarly, mobile units 60-62 control the power of signals transmitted by base stations 10-30 for data transmitted on the forward link.

The power transmitted by mobile units 60-62 is of critical importance since this power is typically supplied by batteries. Transmit power is controlled on both the forward and reverse channels. That is, the base station controls the power which the mobile unit transmits data to the base station and the mobile unit controls the power which the base station transmits data to the mobile unit.

In a CDMA-based cellular system 100, BTSs 10-30 respond to power control commands from the mobile units, or from the Base Station Controller 40, in order to maintain a target frame erasure rate to the mobile units 60, 61, or 62. The total amount of power transmitted by each BTS 10-30 is therefore dependent on the link conditions to each mobile unit, and the amount of traffic load (the number of mobile units and their associated soft handoff legs) that each BTS is carrying.

Each BTS may have one or more sectors. Each sector may have one or more RF carriers (channels) servicing traffic.

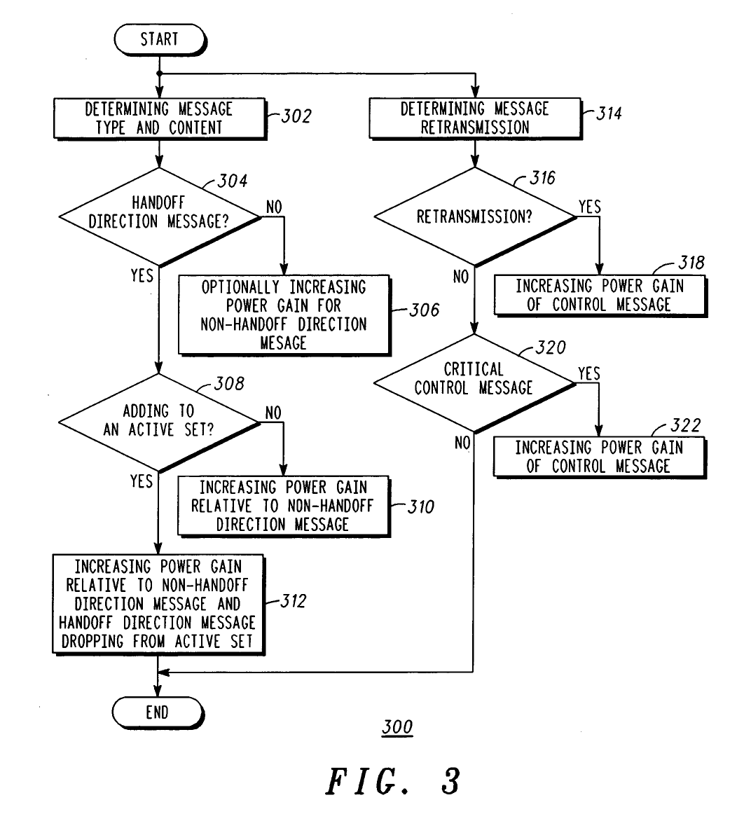

FIG. 2 representatively illustrates a block diagram of a method of sorting control messages in accordance with an exemplary embodiment of the present invention. A network unit 209 of a mobile communication system, for example a cellular communication system 200, is shown communicatively coupled to mobile unit 202 via wireless link 220. In an embodiment, network unit 209 may be at least one of a base station 10-30 or a base station controller 40.

In cellular communication systems, voice/data message traffic 260 may be carried over a traffic channel, while over the air control messages 250 may be sent using a dedicated control channel or performed “in-band”. Use of “in-band” control signaling occurs when bits or entire frames are “stolen” from the traffic channel, which is used to carry the voice or data, in order to carry the necessary control messages. For example, in a cellular communication system, handoff direction messages, power control parameter messages, neighbor list updates, etc. may be sent to a mobile unit “in-band” on a traffic channel. If this “in-band” messaging occurs too frequently, it can negatively impact the voice quality of the traffic channel since bits are being omitted from a speech stream in order to carry signaling or control messages.

In the embodiment shown in FIG. 2, control messages 250 may be sorted by any one of message type 252, message content 254, critical control messages 258, and whether a control message 250 is a retransmission 256. Control messages 250 may be sorted by network unit 209 prior to transmission to mobile unit 202. In another embodiment, network unit 209 may analyze and/or sort and rank control messages 250 according to a set of control message characteristics, which may include but are not limited to, message type 252, message content 254 and whether control message is a retransmission 256.

In an example of an embodiment, control messages 250 may be sorted by message type 252, which may include handoff direction messages, power control parameter messages, neighbor list messages, base station acknowledgment messages, and the like. Handoff direction messages are messages that direct mobile unit 202 to add or drop a base station from an active set, where the active set is a list of base stations currently in communication with mobile unit 202. Power control parameter messages may include messages updating power control parameters used by the mobile unit. Neighbor list messages may include a list of base stations that may be available to establish a communication link with mobile unit 202. Base station acknowledgement messages may be messages that acknowledge reception of a message from the mobile unit.

In an embodiment, control messages 250 may be sorted by message content 254. For example, control messages 250 may be sorted by whether a handoff direction message is adding a pilot to an active set or dropping a pilot from an active set of a call. In another example of an embodiment, control messages 250 may be sorted by whether a power control parameter message would result in an increase in power gain from the mobile unit or a decrease in power gain from the mobile unit.

In a further embodiment, control messages 250 may be sorted by whether the control message 250 is a retransmission of the control message 250. For example, retransmission may be a layer two (L2) transmission as described in the CDMA standard. Messages sent at layer two require an acknowledgment message be returned in order to stop the retransmission of the message. An example would be a base station forwarding an L2 handoff direction message to a mobile unit, which must send an acknowledgment signal back to the base station to be forwarded back to the base station controller. For example, a control message may be sent and 400 milliseconds later the control message is sent again. After another 400 milliseconds, the control message is resent again, etc. When the base station controller receives the acknowledge message from the mobile unit, that control message is no longer sent. So, control message 250 may be sorted by whether the control message is a retransmission of the control message because an acknowledge message has not yet been received.

In still a further embodiment, control messages 250 may be sorted by whether the control message 250 is a critical control message 258. In an embodiment, a critical control message 258 may be, for example and without limitation, a handoff direction message, power control parameter message, neighbor list message, Extended Supplemental Channel Assignment Message (ESCAM), base station acknowledgment message, and the like. In an embodiment, a critical control message 258 may be a control message that must be delivered reliably and cannot be sent L2 acknowledged. This may occur, for example, if there would be insufficient time to send the L2 acknowledge message in the case where immediate action is required as a result of the control message.

In still a further embodiment, control messages 250 may be assigned a ranking factor based on the message type 252. The ranking factor may be used to selectively determine which of control messages 250 receive an increase in power gain and by how much. In other words, the ranking factor may be used to selectively increase the power gain of the control message being sent by a network unit 209 to a mobile unit 202. As an example of an embodiment, a handoff direction message may receive a higher ranking factor relative to a power control parameter message or a neighbor list message. Further, the higher ranking factor may be used for the handoff direction message to receive a power gain increase in excess of the power control parameter message or the neighbor list message.

As shown in FIG.2, control messages 250 may be sorted and/or ranked by message type 252, message content 254, whether control message 250 is a retransmission 256 and whether control message 250 is a critical control message 258. In an embodiment, network unit 209 may selectively increase power gain of the control message based on at least one of message type 252, message content 254, whether the control message is being retransmitted 256, and the like. Further, if control message 250 is not able to be sent and resent, for example with an L2 acknowledge, then control message may be deemed a critical control message 258 with power gain selectively increased as well.

FIG. 3 representatively illustrates a flow diagram 300 of a method of the invention in accordance with an exemplary embodiment of the present invention. In steps 302 and 314, control messages may be sorted by any combination of message type, message content and whether control message is a retransmission.

Sorting control message by message type and/or message content begins at step 302. Message types may include whether control message is a handoff direction message, power control parameter message, neighbor list message, base station acknowledgment message, and the like. Message content may include whether a handoff direction message is adding or dropping a pilot, whether a power control parameter message is requesting a particular type of parameter change, and the like. Control message types and contents other than those listed are within the scope of the invention.

At step 304, it is determined if control message is a handoff direction message. If not, power gain of the control message may be optionally boosted per step 306. If control message is a handoff direction message per step 304, then in step 308 it is determined if handoff direction message is adding to the active set. For example, it is determined if handoff direction message is adding a new pilot signal from a base station to the active set of the mobile unit. If not, the handoff direction message may be dropping from the active set. For example, handoff direction message may be dropping a pilot signal from a currently active base station from the active set. If handoff direction message is not adding to the active set per step 308, then power gain of handoff direction message may be increased relative to a non-handoff direction message per step 310.

If handoff direction message is adding to the active set per step 308, then power gain of handoff direction message is increased relative to a non-handoff direction message and a handoff direction message dropping from the active set per step 312. In an embodiment, steps 304 thru 312 may be used in analogous manner for a power control parameter message. For example, power gain of a power control parameter message may be increased relative to non-power control parameter messages, and further, power gain of the power control parameter message may be increased based on whether the power control parameter message is requesting an increase or decrease in power gain from the mobile unit.

In a further embodiment, steps 304 thru 312 may be used in analogous manner for a base station acknowledgment message. For example, if the acknowledgment message is in response to receiving a pilot strength measurement message (PSMM) corresponding to the mobile unit requesting the addition of a pilot to the active set then the base station acknowledgment message may be sent at an increased power level relative to an acknowledgment sent in response to a PSMM requesting that a pilot be dropped from the active set.

Sorting control messages by whether the control message is a retransmission begins at step 314. For example, retransmission may be a layer two (L2) retransmission as described in the CDMA standard. Messages sent at layer two require an acknowledgment message be returned in order to stop the retransmission of the message. In step 316 it is determined if control message is a retransmission. If so, power gain for the message retransmission is increased per step 318. The power gain may be boosted in this case because the first attempt to deliver the control message was unsuccessful since, for example, no acknowledge message was received back from the mobile unit.

If control message is not a retransmission per step 316, it is determined if control message is a critical control message per step 320. A critical control message may be, for example and without limitation, a handoff direction message, power control parameter message, neighbor list message, ESCAM, and the like. In an embodiment, a critical control message may be a control message that must be delivered reliably and cannot be sent L2 acknowledged. If control message is a critical control message, then power gain is increased per step 322. If not, then power gain is not boosted as indicated by the arrow to the end box. The above method is not limited to L2 retransmission methods but can be used in analogous manner for L3 message transmissions and retransmissions as well.

The above method has the advantage of decreasing call setup failure rates and reducing dropped call rates. Further, the above method has the advantage of reducing forward link transmit power by not wasting power (capacity) by boosting control messages that are non-critical for call setup success and dropped call performance. Instead of the prior art method of boosting all control message traffic, an embodiment of the invention selectively increases the power gain based of a control message based on at least one of the message type, the message content and whether the control message is being retransmitted.

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above.

For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

We claim:

1. In a mobile communication system, an adaptive power control method, comprising:
determining by a network unit of the mobile communication system a message type of a control message transmitted to a mobile unit;
determining message content of the control message;
determining whether the control message is being retransmitted; and
selectively increasing power gain for the control message based on at least one of the message type, the message content and whether the control message is being retransmitted.

2. The mobile communication system of claim 1, wherein determining the message type comprises determining if the message type is a handoff direction message, wherein if the message type is a handoff direction message increasing the power gain for the handoff direction message relative to a non-handoff direction message.

3. The mobile communication system of claim 2, further comprising determining if the handoff direction message is adding to an active set, wherein if the handoff direction message is adding to the active set increasing power gain relative to the handoff direction message dropping from the active set.

4. The mobile communication system of claim 3, further comprising if the handoff direction message is adding to the active set increasing power gain of a base station acknowledgment message relative to the base station acknowledgment message responding to the handoff direction message dropping from the active set.

5. The mobile communication system of claim 1, further comprising assigning a ranking factor to the control message based on the message type and selectively increasing power gain based on the ranking factor.

6. The mobile communication system of claim 5, wherein assigning a ranking factor comprises assigning a higher ranking factor to a handoff direction message relative to at least one of a power control parameter message and a neighbor list message.

7. The mobile communication system of claim 6, wherein the handoff direction message receiving power gain in excess of at least one of the power control parameter message and the neighbor list message.

8. The mobile communication system of claim 1, wherein if the control message is being retransmitted because an acknowledge signal has not been received, increasing power gain for the control message.

9. The mobile communication system of claim 1, if the control message is not being retransmitted, determining if the control message is a critical control message and selectively increasing power gain if the control message is the critical control message.

10. The mobile communication system of claim 1, wherein the network unit includes at least one of a base station and a base station controller.

11. A method for adaptive power control in a mobile communication system, comprising:
prior to transmitting a control message to a mobile unit, a network unit analyzing the control message to determine a set of control message characteristics, wherein the set of control message characteristics comprise:
a message type;
message content;
whether the control message is being retransmitted; and
in transmitting the control message to the mobile unit, selectively increasing power gain for the control message based on at least one of the message type, the message content and whether the control message is being retransmitted.

12. The method of claim 11, wherein determining the message type comprises determining if the message type is a handoff direction message, wherein if the message type is a handoff direction message increasing the power gain for the handoff direction message relative to a non-handoff direction message.

13. The method of claim 12, further comprising determining if the handoff direction message is adding to an active set, wherein if the handoff direction message is adding to the active set increasing power gain relative to the handoff direction message dropping from the active set.

14. The method of claim 13, further comprising if the handoff direction message is adding to the active set increasing power gain of a base station acknowledgment message relative to the base station acknowledgment message responding to the handoff direction message dropping from the active set.

15. The method of claim 11, further comprising assigning a ranking factor to the control message based on the message type and selectively increasing power gain based on the ranking factor.

16. The method of claim 15, wherein assigning a ranking factor comprises assigning a higher ranking factor to a handoff direction message relative to at least one of a power control parameter message and a neighbor list message.

17. The method of claim 16, wherein the handoff direction message receiving power gain in excess of at least one of the power control parameter message and the neighbor list message.

18. The method of claim 11, wherein if the control message is being retransmitted because an acknowledge signal has not been received, increasing power gain for the control message.

19. The method of claim 11, if the control message is not being retransmitted, determining if the control message is a critical control message and selectively increasing power gain if the control message is the critical control message.

20. The method of claim 11, wherein the network unit includes at least one of a base station and a base station controller.

21. A computer-readable medium containing computer instructions for instructing a processor to perform a method of adaptive power control in a mobile communication system, the instructions comprising:
prior to transmitting a control message to a mobile unit, a network unit analyzing the control message to determine a set of control message characteristics, wherein the control message characteristics comprise:
a message type;
message content;
whether the control message is being retransmitted; and
in transmitting the control message to the mobile unit, selectively increasing power gain for the control message based on at least one of the message type, the message content and whether the control message is being retransmitted.

22. The computer-readable medium of claim 21, wherein assigning a ranking factor comprises assigning a higher ranking factor to a handoff direction message relative to at least one of a power control parameter message and a neighbor list message.
